(19) United States
(12) Patent Application Publication
(10) Pub. No.: US 2026/0311446 A1
(43) Pub. Date: Oct. 8, 2026

(54) METHOD FOR FINE-TUNING A MULTIMODAL LARGE LANGUAGE MODEL MACHINE TO GENERATE EDUCATIONAL LEVEL-SPECIFIC FEEDBACK IN SCENE DESCRIPTION TASKS

(71) Applicant: The Education University of Hong Kong, Hong Kong (HK)

(72) Inventors: Leung Ho Philip YU, Hong Kong (HK); Zhiwei XIE, Hong Kong (HK)

(21) Appl. No.: 19/169,024

(22) Filed: Apr. 3, 2025

(51) Int. Cl. G06V 10/44; G06Q 50/20; G06V 10/774

(52) U.S. Cl. CPC G06V 10/44; G06Q 50/20; G06V 10/774

(57) ABSTRACT

The present invention provides a method for fine-tuning a multimodal large language model (MLLM) machine, based on a vision encoder, a vision-language connector and a foundational large language model device, to autonomously generate educational level-specific feedback in scene description tasks with respect to different educational stages. The method comprises: constructing a multimodal training dataset comprising image-text-feedback samples, wherein each image-text-feedback sample includes an image sample, scene-description text sample matched with the image sample, and educational level-specific feedback sample on the descriptive text sample with respect to an educational stage; and fine-tuning the MLLM machine with the constructed multimodal training dataset. The fine-tuned MLLM machine can maximize the pre-trained capabilities of language and visual models to generate precise and pedagogically appropriate educational level-specific feedback while ensuring scalability in terms of data and model size, therefore marking a significant step forward in AI-assisted writing support for education.

### FIELD OF THE INVENTION

The present invention generally relates to multimodal large language model (MLLM). More specifically, the present invention relates to fine-tuning a MLLM machine to generate educational level-specific feedback in scene description tasks with respect to different educational stages.

### BACKGROUND OF THE INVENTION

Language acquisition is a dynamic and interactive process deeply influenced by the interplay between individuals and their surrounding environments. This process extends beyond the confines of traditional classrooms, encompassing a wide range of contexts that offer rich opportunities for experiential learning and reflective engagement. However, conventional teaching methodologies and the scarcity of authentic language learning environments frequently result in passive learning experiences. Students often lack sufficient exposure to real-world scenarios to practice writing, which is essential for fostering active language use and comprehension. They face significant challenges in achieving effective language acquisition due to these authentic context limitations. To that end, more and more researchers propose immersing learners in an authentic language environment by providing more authentic contexts and real-life situations. Thus, recent studies have developed innovative language learning systems that leverage scene description tasks to enhance writing skills. Among these approaches, scene description has emerged as a particularly effective method, providing learners with a rich and authentic environment for language acquisition in an authentic context. A crucial component of this process is feedback, which helps students refine their descriptive skills and improve their writing proficiency.

However, the lack of educational level-specific feedback is a major challenge in implementing scene description tasks. Current feedback mechanisms often provide generalized comments that do not align with students' varying linguistic proficiency and educational stages. For instance, feedback designed for advanced learners may be too complex and discouraging for novices, while feedback tailored to beginners may be too simplistic for more proficient students. This mismatch limits the effectiveness of scene description tasks in helping students improve their writing skills in a way that aligns with their proficiency levels. Therefore, exploring educational level-specific feedback mechanisms is essential to maximizing the benefits of scene description tasks and supporting students' writing development at different educational stages.

With rapid advancement MLLM have emerged as powerful tools capable of processing and integrating information from multiple modalities, such as text and images, making them highly suitable for scene description tasks. MLLMs demonstrate exceptional capabilities in vision-language understanding and content generation, allowing them to provide detailed feedback on descriptive writing. Recent state-of-the-art MLLM, such as GPT-4, Claude-3.5 and Gemini have demonstrated remarkable performance in various tasks, including visual question-answering (VQA), image captioning, and multimodal reasoning. These models leverage large-scale multimodal pretraining, often trained on massive datasets comprising image-text pairs from the web, captioning datasets, and human-annotated vision-language corpora. Their success stems from their ability to align visual embeddings with textual representations, facilitating cross-modal reasoning and context-aware generation. However, despite their success in general vision-language applications, their ability to generate educational level-specific feedback for vision description writing in educational contexts remains limited. This limitation arises primarily from the lack of specialized datasets and fine-grained alignment between visual and textual modalities tailored to different educational stages. Moreover, MLLM often exhibits domain-specific limitations and hallucination issues, particularly in educational applications where precise, pedagogically sound feedback is crucial. These models may generate inaccurate or overly complex feedback, failing to align with students' educational stage. Thus, developing an optimized MLLM for educational level-specific feedback generation requires addressing data limitations and hallucination challenges, ensuring accuracy, consistency and pedagogical appropriateness of feedback in scene description.

Multimodal instruction-following has significantly enhanced MLLMs by enabling them to respond to structured prompts with context-aware outputs. Unlike traditional LLMs that rely on text-based instruction tuning, multimodal instruction tuning incorporates image-instruction-response triplets, allowing models to better align vision and language tasks. However, current multimodal instruction datasets generally lack domain-specific adaptation. Most datasets are created from web-scraped captions or synthetic annotation pipelines, which optimize for instruction diversity rather than fine-grained educational alignment. Existing instruction-following datasets primarily target general-purpose tasks, such as visual question answering, image captioning, and multimodal reasoning, rather than structured feedback generation for specific domains like education. This results in models that adept at general multimodal tasks but struggle to generate structured feedback that aligns with pedagogical principles. Furthermore, hallucination remains a major challenge in instruction-tuned MLLMs, where models generate plausible but incorrect or linguistically inappropriate responses due to insufficient domain grounding.

On the other hand, providing feedback in vision description writing presents unique challenges. Traditional Automated Writing Evaluation (AWE) systems, such as ETS e-rater and Grammarly, focus on grammar correction and fluency assessment in text-only inputs. More advanced intelligent tutoring systems (ITS) and neural essay scoring models assess coherence and organization, but they do not incorporate image-grounded reasoning, making them unsuitable for evaluating vision-based writing tasks. Unlike free-form multimodal generation tasks, scene description requires structured feedback considering linguistic complexity and content relevance to the image. While MLLMs have demonstrated strong multimodal understanding, they lack explicit mechanisms to adjust feedback based on different proficiency levels. Without controlled lexical and syntactic adaptation, MLLM-generated feedback often fails to scaffold learning appropriately, resulting in outputs that are too advanced for beginner students or too simplistic for advanced learners.

Although retrieval-augmented generation has improved factual grounding in LLMs, its application in multimodal feedback remains underexplored. Existing retrieval-based models mainly focus on fact correction and coherence improvement rather than generating tailored writing feedback for educational purposes. A structured feedback model that integrates multimodal input processing with proficiency-aware language generation is essential for improving AI-generated feedback's accuracy and educational effectiveness in scene description.

The vision-language community has seen a rapid increase in publicly available multimodal datasets like COCO and Flickr. These datasets provide abundant parallel image-text data, which have been successfully leveraged in generative pretraining to develop MLLM, such as GPT-4o and LLaVA. However, despite the availability of these datasets, there is a notable lack of multimodal instruction-following datasets specifically designed for generating educational level-specific feedback in scene description tasks. This is partly because creating such a dataset is time-consuming and becomes less structured when relying on human crowd-sourcing.

### SUMMARY OF THE INVENTION

To address above issues, the present invention constructs an educational level-specific feedback dataset for scene description, categorized based on the Hong Kong primary and secondary school English word lists, which classify vocabulary into four distinct educational stages (Key Stages 1-4) and fine-tunes an MLLM machine on this specialized dataset to enhance its ability to generate educationally relevant, educational level-specific feedback.

According to one aspect of the present invention, a method for fine-tuning a MLLM machine to autonomously generate educational level-specific feedback in scene description tasks with respect to different educational stages is provided. The MLLM machine is based on a vision encoder, a vision-language connector and a foundational large language model device. The method comprises: constructing a multimodal training dataset comprising image-text-feedback samples, wherein each image-text-feedback sample includes an image sample, scene-description text sample matched with the image sample, and educational level-specific feedback sample on the descriptive text sample with respect to an educational stage; and fine-tuning the MLLM machine with the constructed multimodal training dataset to generate educational level-specific feedback in scene description tasks by: training the vision encoder to extract visual features of an input image; training the vision-language connector to project the visual features extracted by the vision encoder into word embedding space of the foundational large language model device to obtain a sequence of visual tokens; and training the foundational large language model device to generate educational level-specific feedback based on the obtained sequence of visual tokens.

The fine-tuned MLLM machine can maximize the pre-trained capabilities of large language model (LLM) and visual model while ensuring scalability in terms of both data and model size. Evaluation results unveil that the fine-tuned MLLM machine can generate more precise and pedagogically appropriate educational level-specific feedback, marking a significant step forward in AI-assisted writing support for education.

### BRIEF DESCRIPTION OF THE DRAWINGS

Aspects of the present disclosure may be readily understood from the following detailed description with reference to the accompanying figures. The illustrations may not necessarily be drawn to scale. That is, the dimensions of the various features may be arbitrarily increased or reduced for clarity of discussion. There may be distinctions between the artistic renditions in the present disclosure and the actual apparatus due to manufacturing processes and tolerances. Common reference numerals may be used throughout the drawings and the detailed description to indicate the same or similar components.

FIG. 1 illustrates a flowchart of a method S100 for fine-tuning a MLLM machine for generating educational level-specific feedback in scene description tasks with respect to different educational stages in accordance with one embodiment of the present invention;

FIG. 2 illustrates a system for generation of educational level-specific feedback data for fine-tuning a MLLM machine for generating educational level-specific feedback in scene description tasks with respect to different educational stages in accordance with one embodiment of the present invention; and

FIG. 3 illustrates an architecture of the MLLM machine fine-tuned for generating educational level-specific feedback in scene description tasks with respect to different educational stages in accordance with one embodiment of the present invention.

### DETAILED DESCRIPTION

In the following description, preferred examples of the present invention will be set forth as embodiments which are to be regarded as illustrative rather than restrictive. Specific details may be omitted so as not to obscure the present disclosure; however, the disclosure is written to enable one skilled in the art to practice the teachings herein without undue experimentation.

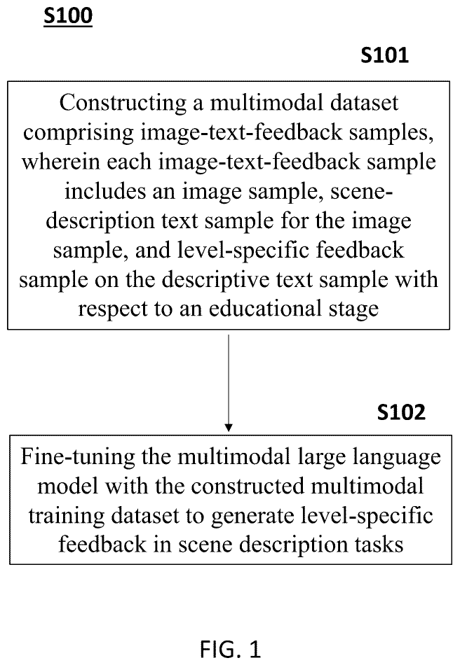

FIG. 1 illustrates a flowchart of a method S100 for fine-tuning a MLLM machine to autonomously generate educational level-specific feedback in scene description tasks with respect to different educational stages in accordance with one embodiment of the present invention. The MLLM machine is based on a vision encoder, a vision-language connector and a foundational large language model device.

The method S100 comprises the following steps:
S101: constructing a multimodal training dataset comprising image-text-feedback samples, wherein each image-text-feedback sample includes an image sample, scene-description text sample for the image sample, and educational level-specific feedback sample on the descriptive text sample with respect to an educational stage; and
S102: fine-tuning the MLLM machine with the constructed multimodal training dataset to generate educational level-specific feedback in scene description tasks by: training the vision encoder to extract visual features of the image samples; training the vision-language connector to project the visual features extracted by the vision encoder into word embedding space of the foundational large language model device to obtain a sequence of visual tokens; and training the foundational large language model device to generate educational level-specific feedback samples based on the obtained sequence of visual tokens

For constructing the multimodal training dataset, images with descriptions written by students of different educational stages are specially selected to form training samples of image-text pairs. To ensure level coverage and data balance, both simple and complex descriptions may be selected for each image, corresponding to different educational stages. Images are selected from the most common topics in Hong Kong primary and secondary school textbooks, including animals, food, home, people, school life, sports, health and city.

The image-text pairs are fed into a generative language model (or generator), which may be a general multimodal LLM (e.g. GPT-4o), to obtain educational level-specific feedback data for training. In some embodiments, each image sample may be paired with multiple (e.g. five) textual description samples, and for every image-text sample pair, feedback sample data may be generated at different (e.g. four) educational stages.

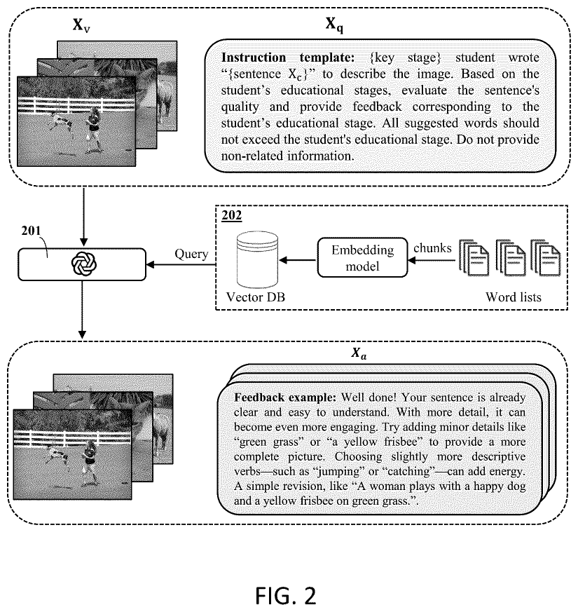

FIG. 2 illustrates a system 200 for generation of educational level-specific feedback data samples for fine-tuning a MLLM machine for generating educational level-specific feedback in scene description tasks with respect to different educational stages in accordance with one embodiment of the present invention. The system may comprise a generator 201; a retriever 202; one or more processors; and a memory in communication with the one or more processors and storing instructions that, when executed by the one or more processors, are configured to cause the system to: receive an image-text pair sample; construct an instruction prompt based on the image-text pair and an instruction template to instruct the generator 201 to generate educational level-specific feedback sample on the image-text pair sample with respect to an educational stage; and output a natural language response as the educational level-specific feedback sample.

As shown in FIG. 2, each image sample Xᵥ is paired with a descriptive sentence sample X_{c} (i.e., image-text sample pair) written by a student. An instruction template is designed to construct an instruction X_{q} to prompt the generator 201 to generate feedback sample corresponding to the sentence X_{c} and instruction X_{q} based on the image sample Xᵥ and an educational stage of the student designated in the instruction X_{q}, and output a natural language response Xₐ as educational level-specific feedback sample.

With (Xᵥ, X_{q}, X_{c}, Xₐ), the created instructions are fed to the generator 201, which may be a general multimodal LLM with image-text pair sample to generate the educational level-specific feedback sample data as:

$$Human : {X}_{q} {X}_{v} < STOP > Assistant : {X}_{c} < STOP >$$

where Human and Assistant serve as special role tokens, while <\n> and <STOP> function as line break and sequence end tokens, respectively.

Moreover, the instruction prompts X_{q} may further require the feedback sample data generated by the generator 201 containing evaluation on the descriptive sentence X_{c} across multiple dimensions, including comprehensiveness, vividness, mechanics, vocabulary choice, and sentence structure.

To ensure the generated feedback samples aligns with educational stages, a Retrieval-Augmented Generation (RAG) framework (or retriever) 202 may be incorporated to the generator 201 to retrieve information from level-specific word list corpus (e.g., the Hong Kong primary and secondary English word list corpus). More specifically, this corpus is structured into four educational stages: key stage 1 (primary 1-3), key stage 2 (primary 4-6), key stage 3 (secondary 1-3) and key stage 4 (secondary 3-6).

In one embodiment, vision transformers (ViT) are adopted to form the vision encoder. A two-layer MLP projector with GELU activation, is employed as the vision-language connector to enhance self-supervised learning performance and improve multimodal capabilities. A general large language model, such as Qwen2, is employed as the foundational LLM device.

The grid features are considered before and after the final Transformer layer. In some embodiments, the vision encoder may be scaled for higher resolutions by segmenting the image into smaller patches that match the resolution on which the vision encoder was initially trained and encoding them independently. Alternatively, the vision encoder may be scaled for higher resolutions by interpolating positional embeddings and modifying the vision encoder backbone during fine-tuning to adapt to the new resolution.

Once the feature maps for individual patches are obtained, they are merged into a unified feature map at the target resolution. To enhance global context and mitigate artifacts from the split-encode-merge process, features from a down-sampled version of the image are concatenated to the merged feature map.

The learning rates for the main model components may be set separately depending on the complexity of each component to have a good balance between efficiency and stability. For example, the learning rates for the foundational LLM device and the ViT may be initialized at 2e-4, while the two-layer MLP may have a learning rate initialized at 2e-5, following a cosine decay schedule with a warm-up ratio (e.g. 3%). More specifically, the learning rate/step is gradually reduced over the training epoch following a cosine function, allowing for smooth and controlled convergence.

For a sequence language instruction X_{q} of length L with respect to an input image Xᵥ, the probability of the target feedback generation Xₐ is computed as:

$$p ( {X}_{a} \vert {X}_{v} , {X}_{q} ) = {\prod }_{i = 1}^{L} p ( {x}_{i} \vert {X}_{v} , {X}_{q , < i} , {X}_{a , < i} ) \qquad ( 1 )$$

where xᵢ denotes tokens predicted by the MLLM machine for generating the target feedback, X_{q,<i} and X_{a,<i} denote the instruction and feedback generation from all previous turns before predicting the token xᵢ, respectively. The instruction X_{q,<i} is an instructional prompt including the description X_{c} written by the student which is concatenated into x_{q} at the input level. The inclusion of Xᵥ explicitly highlights that the visual signal is utilized to generate all feedback.

The MLLM machine is trained on the constructed dataset using the visual instruction tuning approach with 8 NVIDIA A100 40G GPUs. The MLLM machine was initialized from a robust vision-language foundation—employing a pre-trained ViT as the vision encoder and Qwen2 as the foundational LLM device, and a two-layer MLP as the vision-language connector.

More specifically, the MLLM machine learns to generate educational level-specific feedback based on a combination of image input and structured textual prompts. Each training sample consists of four elements: the input image Xᵥ an instruction prompt X_{q} (which includes task-specific guidance and the student's scene description), and the expected output Xₐ, which is the educational level-specific feedback.

The goal of the training was to refine these pre-existing capabilities, using a lightweight and targeted fine-tuning process to improve the model's proficiency in generating educational level-specific feedback for educational image-text pairs.

In one embodiment, the visual encoder weights may be kept frozen throughout training. Therefore, it does not receive gradient updates. While it contributes to the forward pass by providing visual features, the loss function does not update it. Only the vision-language connector and foundational LLM device are trained and optimized jointly.

Based on the Eq. (1), the MLLM machine is fine-tuned by minimizing the negative log-likelihood of the target sequence of tokens constructing the feedback, that is, to minimize the cross-entropy loss function:

$$ℒ = - {\sum }_{i = 1}^{L} log p ( {x}_{i} \vert {X}_{v} , {X}_{q , < i} , {X}_{a , < i} ) , \qquad ( 2 )$$

The training procedure was carried out using a single epoch and a batch size of 16 per GPU device, combined with gradient checkpointing and bf16 precision to reduce memory overhead. More specifically, instead of storing all intermediate activations during backpropagation, only a subset (checkpoint nodes) is stored, and the rest are recomputed on the fly, trading off computation time for memory usage.

In some embodiments, a low-rank adaptation (LoRA) approach is adopted for the training to significantly reduce storage requirements and allow the MLLM machine to adapt to task-specific data without needing large-scale weight updates. Instead of updating the weight matrix of the MLLM machine directly during fine-tuning, LoRA decomposes the change of weight matrix by factorization into trainable low-rank matrices. The MLLM machine is then fine-tuned to have an updated weight matrix computed by adding the change of weight matrix to the pre-trained weight matrix. In one exemplary implementation, the LoRA configuration was set with a rank (r) of 128 and a scaling factor (a) of 256.

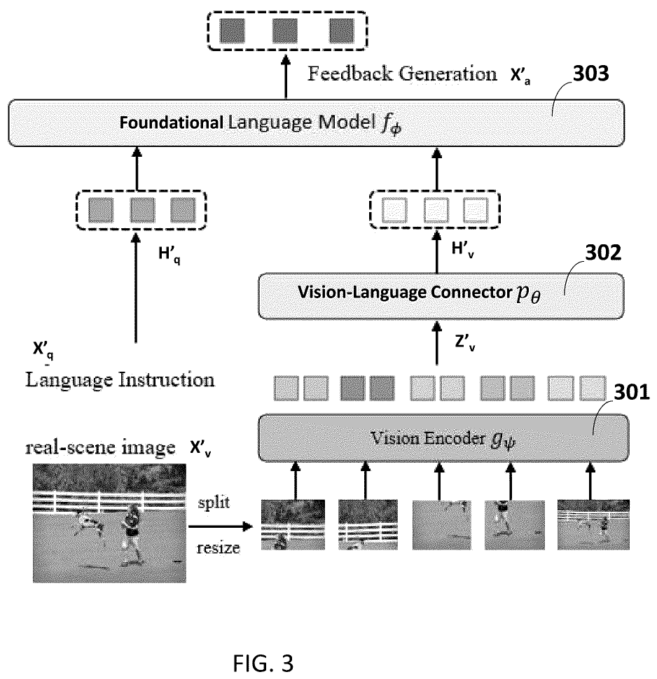

FIG. 3 illustrates an architecture of the MLLM machine 300 fine-tuned to autonomously generate educational level-specific feedback in scene description tasks with respect to different educational stages in accordance with one embodiment of the present invention.

The MLLM machine 300 may comprise a vision encoder module 301; a vision-language connector module 302; a foundational LLM device 303; one or more processors; and a memory in communication with the one or more processors and storing instructions that, when executed by the one or more processors, are configured to cause the fine-tuned MLLM machine to: extract, by the vision encoder, visual features of the image; project, by the vision-language connector, the visual features extracted by the vision encoder into word embedding space of the foundational large language model device to obtain a sequence of visual tokens; and generate, by the foundational LLM device, educational level-specific feedback based on the obtained sequence of visual tokens.

Referring to FIG. 3, the vision encoder 301, denoted as g_{ψ}(⋅), encodes a real-scene image X′ᵥ into its visual feature representation and extract image features Z′ᵥ=g_{ψ}(X′ᵥ). The vision-language connector 302, denoted as p_{θ}(⋅) and parameterized by θ, maps (or projects) image features Z′ᵥ into the word embedding space of the foundational large language model device 303, producing a sequence of visual tokens H′ᵥ=p(Z′ᵥ) to enhance multimodal alignment and ensure seamless information flow from visual inputs to textual outputs, which is a critical requirement for generating high-quality feedback. The foundational LLM 303, denoted as f_{Ø}, generates educational level-specific feedback X′ₐ based on the obtained sequence of visual tokens H′ᵥ and a sequence of text token H′_{q} extracted from the language instruction X′_{q}.

To evaluate the quality of the different models' generative educational level-specific feedback for different educational stages in description writing tasks. A quantitative analysis is conducted to compare the fine-tuned MLLM machine provided by the present invention with open-source state-of-the-art MLLM machine, including LLaVA-1.6 7B and Llama 3.2-Vision 11B. The fine-tuned MLLM machine is evaluated on 600 image-sentence-feedback datasets as ground-truth testing samples not seen during training. Each key stage (1-4) contains 150 image-sentence-feedback samples, allowing for a balanced performance assessment across different proficiency levels.

To measure the semantic alignment between model-generated feedback Fₘ and ground-truth feedback F_{g}, Sentence-BERT (SBERT) similarity scores (Reimers & Gurevych, 2019) is employed. Specifically, Fₘ and F_{g} are represented as two vector representations μ and v. The cosine similarity scores S between vector μ and vector v is computed by Reimers & Gurevych (2019) as follows:

$$S ( {F}_{m} , {F}_{g} ) = cos ( μ , v ) = \frac{μ \cdot v}{‖ μ ‖ \cdot ‖ v ‖}$$

The similarity score ranges from −1 to 1, where higher scores indicate stronger semantic alignment between the generated and ground-truth feedback. This score effectively reflects the fine-tuned MLLM machine's capability to generate appropriate, level-specific responses for different educational stages.

To obtain an overall assessment of performance, the mean SBERT similarity score S̅ across all evaluated samples is computed by:

$$\overline{S} ( {F}_{m}^{′} , {F}_{g}^{′} ) = \frac{1}{N} {\sum }_{i = 1}^{N} S ( {x}_{i} , {y}_{i} )$$

where xᵢ denotes the ith model-generated feedback and yᵢ denotes the ith ground-truth feedback, and N denotes the total number of evaluated samples. The mean SBERT similarity scores across different educational key stages for the evaluated models are shown in Table 1.

TABLE 1
Mean SBERT similarity scores across educational
key stages for different models.

| | Key | Key | Key | Key | |
|---|---|---|---|---|---|
| Model | Stage 1 | Stage 2 | Stage 3 | Stage 4 | Overall |
| LLaVA-1.6 7B | 0.63 | 0.62 | 0.64 | 0.61 | 0.63 |
| Llama 3.2-Vision 11B | 0.73 | 0.74 | 0.75 | 0.72 | 0.74 |
| Fine-tuned MLLM | 0.85 | 0.86 | 0.88 | 0.89 | 0.87 |

From the results shown in Table 1, the mean SBERT similarity scores for the fine-tuned MLLM (of the present invention), LLaVA-1.6 7B, and Llama 3.2-Vision 11B were evaluated across four educational stages. The findings indicate that the fine-tuned model consistently achieves the highest similarity scores, demonstrating stronger semantic alignment with ground-truth feedback.

While SBERT similarity scores provide a comparative measure of model performance, it is essential to determine whether the observed differences between models are statistically significant. A non-parametric statistical test is conducted because the similarity scores deviate from a normal distribution. Therefore, a Wilcoxon signed-rank test is conducted to assess the statistical significance of paired comparisons. The results of the Wilcoxon signed-rank test confirm that the fine-tuned model significantly outperforms both baseline models in terms of similarity scores. Specifically, the comparison between the fine-tuned MLLM and LLaVA-1.6 7B yielded a Wilcoxon test statistic with a p-value (p<0.0001), indicating that the fine-tuned model consistently generates feedback that is more semantically aligned with ground-truth feedback. Likewise, the comparison between the fine-tuned MLLM and Llama 3.2-Vision 11B resulted in a substantial difference, with a p-value (p<0.0001), further demonstrating the improvements introduced by fine-tuning. These results prove that improvements in the fine-tuned model are statistically significant.

To assess the effectiveness of the fine-tuned MLLM in providing appropriate words in feedback. We manually analyzed the average number of words suggested by out-of-level speakers across different models. A random sample of 100 feedbacks are selected to ensure a fair comparison. The results are shown in Table 2.

TABLE 2
The total count of out-of-level suggested
words across different models.

| | LLaVA-1.6 | Llama 3.2-Vision | Our Fine-tuned |
|---|---|---|---|
| | 7B | 11B | MLLM |
| Total out-of- | 4.29 | 3.39 | 0.75 |
| Level Words | | | |
| (N = 100) | | | |

To assess the statistical significance of these differences, a Wilcoxon signed-rank test is conducted, which confirmed that the fine-tuned MLLM significantly reduces out-of-level word suggestions compared to both LLaVA-1.6 7B (p<0.0001) and Llama 3.2-Vision 11B (p<0.0001). These findings highlight that Fine-tuned MLLM has a significantly lower chance of suggesting words beyond the student's educational stage.

Qualitative analysis is essential to examine feedback's linguistic appropriateness and contextual relevance at different educational stages. In Table 3, we provide a qualitative comparison between the fine-tuned MLLM's results with LLaVA-1.6 7B and Llama 3.2 Vision 11B with respect to the exemplary real-scene image shown in FIG. 3. This section presents representative examples from key stage 2 and key stage 3 to illustrate how the fine-tuned MLLM adapts feedback to varying student proficiency levels. Assume that the key stage 2 and key stage 3 students both wrote the same sentence, “A woman playing with a dog.” to describe the image. We compare the fine-tuned MLLM with LLaVA-1.6 7B and Llama 3.2-Vision 11B in Table 3.

For key stage 2, LLaVA-1.6 7B suggests phrases like “sleek black shirt” and “engaging in a lively game” instead of using simple, more natural alternatives. It also proposes phrases like “leaping with boundless energy” or “springing effortlessly into the air”, which, while vivid, might be too complex for key stage 2 students to understand and use in their writing. Llama 3.2-Vision 11B follows a similar pattern, offering elaborate descriptions such as “a radiant woman in a black shirt twirls gracefully” and “grabs the frisbee mid-air”. These choices introduce words like “radiant”, “twirls”, and “snatches”, which may not align with the vocabulary expected at this educational level. For key stage 3, students can handle more nuanced refinements but still require feedback that aligns with their educational level. LLaVA-1.6 7B suggests words like “hurls”, “catapults”, “dexterous”, and “aerodynamic”, which are not suitable for student's educational stage. Similarly, Llama 3.2-Vision 11B encourages dense and overly complex descriptions such as “Her dog launching in synchronized motion, eyes locked on its airborne target” and “paws outstretched in anticipation”. These suggestions include words like “synchronized”, “contorts”, and “spirals”, which make sentences feel overly elaborate rather than naturally expressive. In contrast, the fine-tuned MLLM of the present invention provides educational stage appropriate that students can easily apply, such as replacing “playing” with “jumping” or “catching” while maintaining clarity

TABLE 3
An example of model generative feedback among key stage 2 and key stage 3. The
words not suitable for the corresponding educational stage are underlined.

| | |
|---|---|
| Scene | |
| Description | |
| Sentence for | |
| the Image | A woman playing with a dog. |

Key stage 2

| | |
|---|---|
| LLaVA-1.6 | Your sentence conveys the core action. To improve it further, incorporating |
| 7B | more nuanced details will enhance clarity and engagement. Try specifying |
| | details like “a woman clad in a sleek black shirt” to provide a clearer image. |
| | Instead of “playing,” consider a more vivid verb such as “engaging in a lively |
| | game” to add depth. The dog's movement could be described as “leaping with |
| | boundless energy” or “springing effortlessly into the air.” Additionally, |
| | small refinements—such as changing “playing” to “is joyfully playing”—can |
| | make the sentence more fluid. |
| Llama 3.2- | Your description has covered the main object, and incorporating more |
| Vision 11B | precise and evocative language will make it even more immersive. Try using |
| | words that add more movement and energy, such as “A radiant woman in a |
| | black shirt twirls gracefully” or “Her lively dog jumps high to grab the frisbee |
| | mid-air.” You could say “leaps with ease” or “springs up |
| | excitedly.” Dynamic verbs like “twirls” or “snatches” will add more action |
| | to the sentence. |
| Fine-tuned | Well done! Your sentence is already clear and easy to understand. With more |
| MLLM | detail, it can become even more engaging. Try adding minor details like |
| provided by | “green grass” or “a yellow frisbee” to provide a more complete picture. |
| the present | Choosing slightly more descriptive verbs—such as “jumping” or |
| invention | “catching”—can add energy. A simple revision, like “A woman plays with a |
| | happy dog and a yellow frisbee on green grass.”, keeps it clear while making |
| | it more vivid. You are doing great—keep practicing, and your writing will |
| | improve! |

Key stage 3

| | |
|---|---|
| LLaVA-1.6 | The sentence conveys the main action but lacks depth and detail. Expanding |
| 7B | on the setting and movements would improve clarity and engagement. |
| | Introducing precise descriptors such as “a woman clad in a moisture-wicking |
| | sports jersey” would add specificity. Replace general verbs like “playing” |
| | with more dynamic alternatives, such as “hurls” and “catapults”. The |
| | sentence structure is too basic. Incorporating adjectives like “dexterous”, |
| | “kinetic”, or “aerodynamic” would further refine the imagery. |
| Llama 3.2- | The description captures the core action but lacks complexity and immersive |
| Vision 11B | detail. A more multisensory and kinetic approach would improve depth. |
| | Consider elevating the action with layered descriptions—e.g., “A woman, |
| | draped in a billowing black top, pivots sharply as she flings a frisbee, her dog |
| | launching in synchronized motion, eyes locked on its airborne target.” Using |
| | kinetic and tactile vocabulary enhances immersion—“the dog's sinewy |
| | frame contracts before it springs skyward, paws outstretched in |
| | anticipation.” Replace common verbs with more evocative choices |
| | like “propels”, “spirals”, “contorts” or “snatches mid-flight.” Varying |
| | sentence lengths and integrating rhetorical devices (e.g., metaphor, cadence |
| | shifts) will add stylistic richness. |
| Fine-tuned | The sentence lacks the vivid detail needed for a more compelling image. |
| MLLM | Instead of “playing,” use a more descriptive action verb such as “tosses” or |
| provided by | “throw”. Describe how the dog reacts to the frisbee to enhance its movement. |
| the present | Adding adjectives like “quick,” “focused,” or “graceful” will improve the |
| invention | description. A more developed sentence structure, such as “A woman throws |
| | a frisbee across the open field, her energetic dog leaping high to grab it before |
| | landing lightly on the grass,” creates a smoother and more engaging flow. |

For key stage 2, LLaVA-1.6 7B suggests phrases like “sleek black shirt” and “engaging in a lively game” instead of using simple, more natural alternatives. It also proposes phrases like “leaping with boundless energy” or “springing effortlessly into the air”, which, while vivid, might be too complex for key stage 2 students to understand and use in their writing. Llama 3.2-Vision 11B follows a similar pattern, offering elaborate descriptions such as “a radiant woman in a black shirt twirls gracefully” and “grabs the frisbee mid-air”. These choices introduce words like “radiant”, “twirls”, and “snatches”, which may not align with the vocabulary expected at this educational level. For key stage 3, students can handle more nuanced refinements but still require feedback that aligns with their educational level. LLaVA-1.6 7B suggests words like “hurls”, “catapults”, “dexterous”, and “aerodynamic”, which are not suitable for student's educational stage. Similarly, Llama 3.2-Vision 11B encourages dense and overly complex descriptions such as “Her dog launching in synchronized motion, eyes locked on its airborne target” and “paws outstretched in anticipation”. These suggestions include words like “synchronized”, “contorts”, and “spirals”, which make sentences feel overly elaborate rather than naturally expressive. In contrast, the fine-tuned MLLM of the present invention provides educational stage appropriate that students can easily apply, such as replacing “playing” with “Jumping” or “catching” while maintaining clarity.

The functional units and modules in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

1. A method for fine-tuning a multimodal large language model machine to autonomously generate educational level-specific feedback in scene description tasks with respect to different educational stages, wherein the multimodal large language model machine is based on a vision encoder, a vision-language connector and a foundational large language model device, and the method comprising:
constructing a multimodal training dataset comprising image-text-feedback samples, wherein each image-text-feedback sample includes an image sample, scene-description text sample matched with the image sample, and a corresponding educational level-specific feedback sample with respect to an educational stage; and
fine-tuning the multimodal large language model machine with the constructed multimodal training dataset to generate educational level-specific feedback in scene description tasks by:
training the vision encoder to extract visual features of an input image;
training the vision-language connector to project the visual features extracted by the vision encoder into word embedding space of the foundational large language model device to obtain a sequence of visual tokens; and
training the foundational large language model device to generate educational level-specific feedback based on the obtained sequence of visual tokens.

2. The method of claim 1, wherein the multimodal training dataset is constructed by:
selecting one or more scene-description text samples for each image sample to form one or more image-text sample pairs respectively; and
generating one or more educational level-specific feedback samples corresponding to each image-text sample pair with respect to one or more educational stages; and
mapping the generated educational level-specific feedback samples with the image-text sample pairs for each educational stage to form the image-text-feedback samples.

3. The method of claim 2, wherein the one or more scene-description text samples are selected from description written by students at different educational stages.

4. The method of claim 3, each educational level-specific feedback sample is generated by using a retrieval-augmented generation network comprising:
a retriever configured to retrieves educationally appropriate vocabulary from a predefined corpus structured into multiple educational stages; and
a generator configured to generate the educational level-specific feedback sample based on the retrieved educationally appropriate vocabulary.

5. The method of claim 1, further comprising designing an instruction prompt template for configuring the generator to generate the educational level-specific feedback sample with respect to a designated educational stage across multiple metrics including comprehensiveness, vividness, mechanics, vocabulary choice, and sentence structure.

6. The method of claim 1, wherein
the vision encoder is a vision transformer pre-trained for visual feature extraction; and
the vision-language connector is a two-layer multilayer perceptron projector with gaussian error linear unit (GELU) activation pretrained for enhancing alignment of visual and textual features.

7. The method of claim 1, wherein the multimodal large language model machine is fine-tuned by adopting low-rank adaptation (LoRA) to update a weight matrix of the multimodal large language model machine.

8. The method of claim 7, wherein the low-rank adaptation is set to have a rank of 128 and a scaling factor of 256.

9. The method of claim 1, further the multimodal large language model machine is fine-tuned using a visual instruction tuning approach.

10. The method of claim 1, wherein the vision encoder is trained to extract visual features of image samples by:
segmenting each image sample into patches;
performing independent encoding on each patch to extract visual feature from the patch; and
concatenating visual features extracted from the patches to obtain a unified feature map of for the image sample.

11. An artificial intelligence-based method of using a multimodal large language model machine fine-tuned with the method of claim 1 to autonomously generate educational level-specific feedback on scene description tasks with respect to different educational stages.

12. The artificial intelligence-based method of claim 11, wherein the multimodal training dataset is constructed by:
selecting one or more scene-description text samples for each image sample to form one or more image-text sample pairs respectively; and
generating one or more educational level-specific feedback samples corresponding to each image-text sample pair with respect to one or more educational stages; and
mapping the generated educational level-specific feedback samples with the image-text sample pairs for each educational stage to form the image-text-feedback samples.

13. The artificial intelligence-based method of claim 12, wherein the one or more scene-description text samples are selected from description written by students at different educational stages.

14. The artificial intelligence-based method of claim 13, wherein each educational level-specific feedback sample is generated by using a retrieval-augmented generation network comprising:
a retriever configured to retrieves educationally appropriate vocabulary from a predefined corpus structured into multiple educational stages; and
a generator configured to generate the educational level-specific feedback sample based on the retrieved educationally appropriate vocabulary.

15. The artificial intelligence-based method of claim 11, further comprising designing an instruction prompt template for configuring the generator to generate the educational level-specific feedback sample with respect to a designated educational stage across multiple metrics including comprehensiveness, vividness, mechanics, vocabulary choice, and sentence structure.

16. The artificial intelligence-based method of claim 11, wherein
the vision encoder is a vision transformer pre-trained for visual feature extraction; and
the vision-language connector is a two-layer multilayer perceptron projector with gaussian error linear unit (GELU) activation pretrained for enhancing alignment of visual and textual features.

17. The artificial intelligence-based method of claim 11, wherein the multimodal large language model machine is fine-tuned by adopting low-rank adaptation (LoRA) to update a weight matrix of the multimodal large language model machine.

18. The artificial intelligence-based method of claim 17, wherein the low-rank adaptation is set to have a rank of 128 and a scaling factor of 256.

19. The artificial intelligence-based method of claim 11, further the multimodal large language model machine is fine-tuned using a visual instruction tuning approach.

20. The artificial intelligence-based method of claim 11, wherein the vision encoder is trained to extract visual features of image samples by:
segmenting each image sample into patches;
performing independent encoding on each patch to extract visual feature from the patch; and
concatenating visual features extracted from the patches to obtain a unified feature map of for the image sample.
